(19) United States
(12) Patent Application Publication
(10) Pub. No.: US 2025/0112232 A1
(43) Pub. Date: Apr. 3, 2025

(54) CATHODE ACTIVE MATERIAL AND AQUEOUS BATTERY

(71) Applicants: TOYOTA JIDOSHA KABUSHIKI KAISHA, Toyota-shi (JP); TOKYO INSTITUTE OF TECHNOLOGY, Tokyo (JP)

(72) Inventors: Hiroshi SUYAMA, Mishima-shi (JP); Shigeki SATO, Fujinomiya-shi (JP); Hajime ARAI, Tokyo (JP); Atsunori IKEZAWA, Tokyo (JP)

(73) Assignees: TOYOTA JIDOSHA KABUSHIKI KAISHA, Toyota-shi (JP); TOKYO INSTITUTE OF TECHNOLOGY, Tokyo (JP)

(21) Appl. No.: 18/899,582

(22) Filed: Sep. 27, 2024

(30) Foreign Application Priority Data
Oct. 3, 2023 (JP) 2023-171999
Sep. 18, 2024 (JP) 2024-161106

(51) Int. Cl. H01M 4/505; H01M 4/02; H01M 4/06; H01M 10/26

(52) U.S. Cl. CPC H01M 4/505; H01M 4/06; H01M 10/26; H01M 2004/028; H01M 2300/0002

(57) ABSTRACT

A cathode active material in the present disclosure has a monoclinic crystal structure that belongs to a space group C2/m, and has a composition shown as a composition formula: AₓMn_{1-y}Bi_{y}O₂·zH₂O (A: one or both of Na and K, 0<x<1, 0<y<1, 0<z<2).

### CROSS-REFERENCE TO RELATED APPLICATION

This application claims priority to Japanese Patent Application No. 2023-171999 filed on Oct. 3, 2023, and Japanese Patent Application No. 2024-161106 filed on Sep. 18, 2024. The disclosure of the above-identified applications, each of which includes the specification, drawings, and claims, is incorporated by reference herein in their entirety.

### BACKGROUND

### 1. Technical Field

The present application relates to a cathode active material and an aqueous battery.

### 2. Description of Related Art

International Publication No. WO 2020/237386 discloses a layered potassium metal oxide shown as KₓM_{y}Mn_{1-y}O₂ (M: Co, Fe, Ni, Ti, Cr, V, Cu, Zr, Sb, or a combination of them), as a cathode material of a non-aqueous potassium-ion battery.

### SUMMARY

A novel cathode active material that can be used in an aqueous battery including an aqueous electrolyte solution containing potassium polyphosphate is demanded.

The present application discloses a plurality of aspects described below, as means for solving the above problem.

### <Aspect 1>

A cathode active material having a monoclinic crystal structure that belongs to a space group C2/m,
the cathode active material having a composition shown as follows,

AₓMn_{1-y}Bi_{y}O₂·zH₂O Composition formula:
A: one or both of Na and K

$$0 < x < 1$$

$$0 < y < 1$$

$$0 < z < 2 ,$$

the cathode active material being used in an aqueous battery including an aqueous electrolyte solution containing water and potassium polyphosphate that is dissolved in the water.

### <Aspect 2>

An aqueous battery comprising:
a cathode active material layer;
an aqueous electrolyte solution; and
an anode active material layer, wherein:
the cathode active material layer contains the cathode active material according to aspect 1; and
the aqueous electrolyte solution contains water and potassium polyphosphate that is dissolved in the water.

### <Aspect 3>

The aqueous battery according to aspect 2, wherein the aqueous electrolyte solution contains water and potassium polyphosphate that is dissolved at a concentration of 2.0 mol or more per 1 kg of the water.

### <Aspect 4>

The aqueous battery according to aspect 2 or 3, wherein the aqueous electrolyte solution contains water and potassium pyrophosphate as the potassium polyphosphate that is dissolved in the water.

### <Aspect 5>

The aqueous battery according to any one of aspects 2 to 4, wherein a pH of the aqueous electrolyte solution is 3 or higher and 13 or lower.

The cathode active material in the present disclosure can be used as a cathode active material of an aqueous battery including an aqueous electrolyte solution containing potassium polyphosphate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of the configuration of an aqueous battery;

FIG. 2 shows X-ray diffraction patterns of cathode active materials according to an example and a comparative example;

FIG. 3 shows discharge curves of cells according to the example and the comparative example;

FIG. 4 shows a relation between the potassium pyrophosphate concentration in an aqueous electrolyte solution and the ion conductivity of the aqueous electrolyte solution; and

FIG. 5 shows a relation between the potassium pyrophosphate concentration in the aqueous electrolyte solution and the pH of the aqueous electrolyte solution.

### DETAILED DESCRIPTION OF EMBODIMENTS

### 1. Cathode Active Material

There are not many report examples about inorganic compounds that can function as an active material in an aqueous electrolyte solution that contains potassium ions and that is not a strong alkali. In addition, there is not much knowledge about inorganic compounds that can be used as the active material, and at present, activities of a number of inorganic compounds are checked one by one. Particularly, the study about aqueous batteries in which aqueous electrolyte solutions containing potassium polyphosphate are used is still developing, and there are fewer report examples about the active material. In this regard, a novel cathode active material that can be used in the aqueous battery including the aqueous electrolyte solution containing potassium polyphosphate is demanded. For example, the cathode active material for the aqueous battery including the aqueous electrolyte solution containing potassium polyphosphate has room for improvement in discharge capacity. The inventors have searched a novel material that functions as the cathode active material of the aqueous battery including the aqueous electrolyte solution containing potassium polyphosphate, and have found that a complex oxide disclosed below has a high discharge capacity as the cathode active material of the aqueous battery including the aqueous electrolyte solution containing potassium polyphosphate.

A cathode active material in the present disclosure has a monoclinic crystal structure that belongs to a space group C2/m, has a composition shown as a composition formula: AₓMn_{1-y}Bi_{y}O₂·zH₂O (A: one or both of Na and K, 0<x<1, 0<y<1, 0<z<2), and is used in an aqueous battery including an aqueous electrolyte solution containing water and potassium polyphosphate that is dissolved in the water. By having such a crystal structure and composition, the cathode active material in the present disclosure can store and release ions contained in the aqueous electrolyte solution, as charge compensation ions.

### 1.1 Crystal Structure

The cathode active material in the present disclosure has the monoclinic crystal structure that belongs to the space group C2/m. For example, the cathode active material in the present disclosure may be a material that has diffraction peaks at least at 2θ=12.2°±±0.5°, 24.5°±1.0°, in an X-ray diffraction pattern in which CuKα is adopted as a radiation source. The position of the diffraction peak can change depending on the molar ratio of Mn and Bi that compose the cathode active material, and the like.

In an aspect, it can be said that the cathode active material in the present disclosure is a material in which Bi exists in the crystal structure of layered manganese oxide that has the monoclinic crystal structure. It is thought that the stabilization of the crystal structure and/or the change in the electronic state in the crystal is caused by the existence of Bi in the crystal structure of layered manganese oxide that has the monoclinic crystal structure. Therefore, it is thought that charge compensation ions easily go into between layers in the crystal structure and the discharge capacity of the cathode active material increases.

### 1.2 Composition

The cathode active material in the present disclosure has the composition shown as the composition formula: AₓMn_{1-y}Bi_{y}O₂·zH₂O. Here, A is one or both of Na and K. In the cathode active material in the present disclosure, even in the case where Na is contained as A or even in the case where K is contained as A, charge compensation ions can be removed and inserted. Further, x is more than zero, and may be 0.01 or more, 0.02 or more, 0.03 or more, 0.04 or more, or 0.05 or more. Further, x is less than 1, and may be 0.75 or less, 0.50 or less, 0.25 or less, 0.20 or less, 0.15 or less, 0.10 or less, 0.09 or less, 0.08 or less, 0.07 or less, 0.06 or less, or 0.05 or less. Further, y is more than zero, and may be 0.01 or more, 0.02 or more, 0.03 or more, or 0.04 or more. Further, y is less than 1, and may be 0.75 or less, 0.50 or less, 0.25 or less, 0.20 or less, 0.15 or less, 0.10 or less, 0.09 or less, 0.08 or less, 0.07 or less, 0.06 or less, 0.05 or less, or 0.04 or less. Further, z is more than zero, and may be 0.2 or more, 0.4 or more, 0.8 or more, 1.0 or more, 1.2 or more, 1.4 or more, 1.6 or more, or 1.8 or more. Further, z is less than 2, and may be 1.8 or less, 1.6 or less, 1.4 or less, 1.2 or less, 1.0 or less, 0.8 or less, 0.4 or less, or 0.2 or less.

### 1.3 Supplement of Element Disposition in Crystal Structure

The element disposition of the cathode active material in the present disclosure only needs to have the above crystal structure, while having the above composition. In the cathode active material in the present disclosure, for example, A and H₂O may exist between layers configured as a Mn—O octahedron. Further, in the cathode active material in the present disclosure, for example, Bi may exist in a space having the above crystal structure. Alternatively, for example, some of Mn may be displaced by Bi, at Mn sites (Mn sites of monoclinic layered manganese oxide) of the cathode active material in the present disclosure.

### 1.4 Shape

The shape of the cathode active material in the present disclosure may be a shape that is general as the cathode active material of the battery. For example, the cathode active material in the present disclosure may be a particle shape. In this case, the particle diameter is not limited, and an appropriate size may be selected depending on the design of the battery. The cathode active material in the present disclosure may be a primary particle, or may be a secondary particle in which a plurality of primary particles is aggregated. For example, the average particle diameter D50 of the cathode active material in the present disclosure may be 1 nm or more and 1000 μm or less. The lower limit may be 5 nm or more or 10 nm or more, and the upper limit may be 500 μm or less, 100 μm or less, 50 μm or less, or 30 μm or less. The average particle diameter D50 in the present application is a particle diameter (median size) at an integrated value of 50% in a volume-based particle size distribution that is evaluated by a laser diffraction/scattering method.

### 2. Production Method for Cathode Active Material

A complex oxide that has a crystal structure belonging to a space group C2/m and contains Mn and Bi as in the case of the cathode active material in the present disclosure can be synthesized by blending and baking raw materials to obtain a predetermined precursor and thereafter performing a post-treatment to the precursor (soft chemical method), for example. For example, the production method for the cathode active material in the present disclosure may include:
obtaining a blended material by blending a Mn source and a Bi source with one or both of a Na source and a K source;
obtaining a precursor by baking the blended material; and obtaining the cathode active material by performing an acid treatment to the precursor.

### 2.1 Blending

The blending of the Na and/or K source, the Mn source and the Bi source can be executed by known blending means such as a ball mill. The blending may be a dry blending, or may be a wet blending in which a dispersion medium or the like is used. For example, the Na source may be sodium carbonate. For example, the K source may be potassium carbonate. For example, the Mn source may be manganese oxide. For example, the Bi source may be bismuth oxide. One kind of compound may serve as two or more sources of the Na source, the K source, the Mn source and the Bi source. In the production method in the present disclosure, for example, the Na and/or K source, the Mn source and the Bi source may be blended at predetermined ratios, such that the crystal structure of the precursor after the baking is a α-NaMnO₂ type crystal structure.

### 2.2 Baking

The baking of the blended material can be executed by known baking means such as a baking furnace. For example, the baking atmosphere for the blended material may be an inactive gas atmosphere such as a nitrogen atmosphere, or may be an oxygen-containing atmosphere. For example, the temperature increase rate from a baking start temperature (for example, room temperature) to a baking temperature may be 50° C./h or higher and 500° C./h or lower. For example, the baking temperature may be 700° C. or higher and 800° C. or lower. For example, the baking time may be 5 hours or more and 100 hours or less.

### 2.3 Acid Treatment

The acid treatment is performed to the precursor obtained as described above, and thereby, the cathode active material having a desired crystal structure and composition is obtained. The acid treatment is executed by the contact of the above precursor with various acid solutions. The acid composing the acid solution may be an inorganic acid or may be an organic acid. Particularly, the inorganic acid is suitably used. For example, the inorganic acid may be sulfuric acid. The concentration and temperature of the acid solution only need to be a concentration and temperature that allow an appropriate acid treatment. For example, the time of the acid treatment (the time of the contact between the precursor and the acid solution) may be 5 hours or more and 100 hours or less. After the acid treatment, water washing, drying, and the like may be optionally performed.

### 3. Aqueous Battery

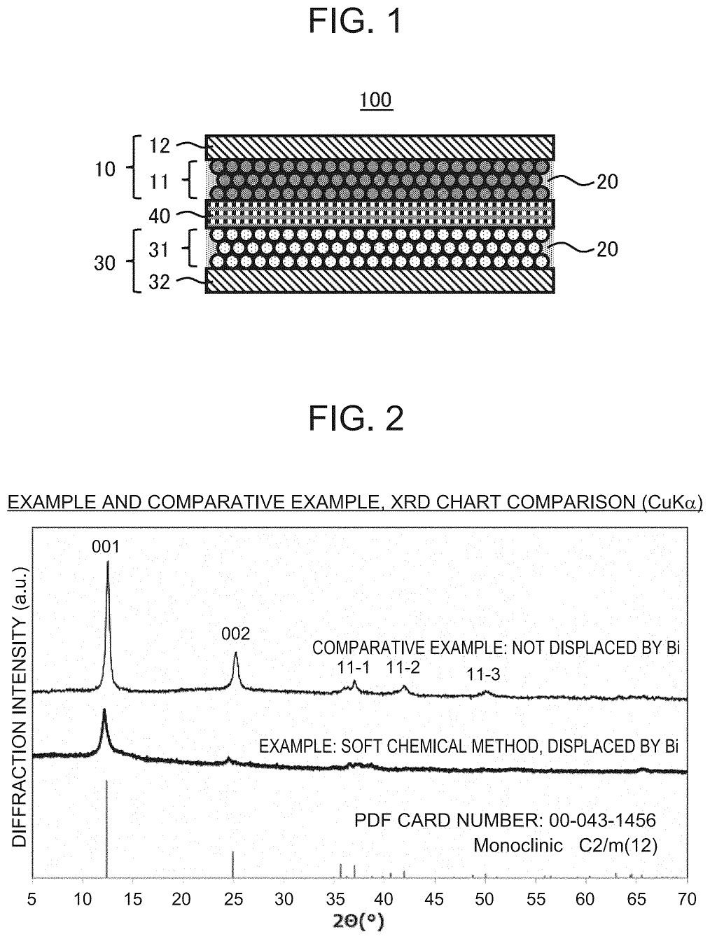

As shown in FIG. 1, an aqueous battery 100 according to an embodiment includes a cathode active material layer 11, an aqueous electrolyte solution 20, and an anode active material layer 31. The cathode active material layer 11 contains the cathode active material in the present disclosure, that is, the cathode active material having the monoclinic crystal structure that belongs to the space group C2/m and having the composition shown as the composition formula: AₓMn_{1-y}Bi_{y}O₂·zH₂O (A: one or both of Na and K, 0<x<1, 0<y<1, 0<z<2). The aqueous electrolyte solution 20 contains water and potassium polyphosphate that is dissolved in the water.

### 3.1 Cathode Active Material Layer

The cathode active material layer 11 contains the cathode active material in the present disclosure. Further, the cathode active material layer 11 can be impregnated with the aqueous electrolyte solution 20. Further, the cathode active material layer 11 may contain a conductive auxiliary agent, a binder, various additive agents, and the like, other than the cathode active material. The content of each component in the cathode active material layer 11 may be appropriately determined depending on an intended battery performance. The shape of the cathode active material layer 11 is not particularly limited, and for example, a sheet-shaped cathode active material layer having a roughly planar surface may be adopted.

### 3.1.1 Cathode Active Material

The cathode active material layer 11 may contain only the above cathode active material in the present disclosure, as the cathode active material. Alternatively, the cathode active material layer 11 may contain a different cathode active material, together with the cathode active material in the present disclosure. With respect to the total amount (100 mass %) of the cathode active material contained in the cathode active material layer 11, the cathode active material in the present disclosure may be contained at more than 0 mass % and 100 mass % or less, at 10 mass % or more and 100 mass % or less, at 30 mass % or more and 100 mass % or less, or at 50 mass % or more and 100 mass % or less. The different cathode active material may contain the K element. Specifically, there are an oxide, polyanion and others that contains the K element. More specifically, complex oxides of potassium and various transition metals may be adopted. Even in the case where K sites in the complex oxide are composed of another alkali metal element, there is a possibility that various ions contained in the aqueous electrolyte solution 20 can be removed and inserted. Alternatively, the different cathode active material may be Prussian blue or the like. Alternatively, the different cathode active material may be at least one kind selected from potassium titanate, TiO₂, sulfur (S), and the like that have higher charge-discharge electric potentials than a later-described anode active material. For example, the different cathode active material may have a particle shape. The different cathode active material may be a primary particle, or may be a secondary particle in which a plurality of primary particles is aggregated. For example, the average particle diameter D50 of the different cathode active material may be 1 nm or more and 1000 μm or less. The lower limit may be 5 nm or more or 10 nm or more, and the upper limit may be 500 μm or less, 100 μm or less, 50 μm or less, or m or less.

### 3.1.2 Conductive Auxiliary Agent

Examples of the conductive auxiliary agent that can be contained in the cathode active material layer 11 include carbon materials such as vapor grown carbon fiber (VGCF), acetylene black (AB), Ketjen black (KB), carbon nanotube (CNT), and carbon nanofiber (CNF); and metal materials that is hardly soluble in the aqueous electrolyte solution, as exemplified by nickel, titanium, aluminum, and stainless steel. The conductive auxiliary agent may have a particle shape or a fiber shape, for example, and the size is not particularly limited. As the conductive auxiliary agent, only one kind may be used alone, or two kinds or more may be combined and used.

### 3.1.3 Binder

Examples of the binder that can be contained in the cathode active material layer 11 include a butadiene rubber (BR) binder, a butylene rubber (IIR) binder, an acrylate-butadiene rubber (ABR) binder, a styrene-butadiene rubber (SBR) binder, a polyvinylidene fluoride (PVdF) binder, a polytetrafluoroethylene (PTFE) binder, and a polyimide (PT) binder. As the binder, only one kind may be used alone, or two kinds or more may be combined and used.

### 3.2 Cathode Current Collector

As exemplified in FIG. 1, a cathode 10 of the aqueous battery 100 can include a cathode current collector 12 that contacts with the above cathode active material layer 11. The cathode current collector 12 may contact with the aqueous electrolyte solution 20. For the cathode current collector 12, any cathode current collector that can function as the cathode current collector of the aqueous battery can be employed. The cathode current collector 12 may be a foil, a plate, a mesh, a punched metal, a foam, or the like. The cathode current collector 12 may be composed of a metal foil or a metal mesh. Particularly, the metal foil has a high handling property and the like. The cathode current collector 12 may be constituted by a plurality of foils. As the metal material composing the cathode current collector 12, for example, there is a material containing at least one element that is selected from a group constituting of Cu, Ni, Al, V, Au, Pt, Mg, Fe, Ti, Pb, Co, Cr, Zn, Ge, In, Sn, and Zr. The cathode current collector 12 may be formed by plating or evaporating the above metal on a metal foil or a base material. Further, in the case where the cathode current collector 12 is constituted by a plurality of metal foils, some kind of layer may be provided among the plurality of metal foils. The thickness of the cathode current collector 12 is not particularly limited. For example, the thickness may be 0.1 μm or more or 1 μm or more, and may be 1 mm or less or 100 μm or less.

### 3.3 Aqueous Electrolyte Solution

The aqueous electrolyte solution 20 contains water and an electrolyte dissolved in the water. The aqueous electrolyte solution 20 may contact with the above-described cathode current collector 12, may be contained in the above-described cathode active material layer 11, may contact with a later-described anode current collector 32, may be contained in a later-described anode active material layer 31, and may be held by a separator 40 between the cathode active material layer 11 and the anode active material layer 31.

### 3.3.1 Solvent

The aqueous electrolyte solution 20 contains water as a solvent. The solvent contains water as a main component. That is, with respect to the total amount (100 mol %) of solvents composing the aqueous electrolyte solution, water is contained at 50 mol % or more and 100 mol % or less. Water may be contained at 70 mol % or more, 90 mol % or more, or 95 mol % or more of the total amount of the solvent. On the other hand, the upper limit of the proportion of water in the solvent is not particularly limited. The solvent may be composed of only water (water 100 mol %). For example, from the standpoint of the formation of a solid electrolyte interphase (SEI) on the surface of the active material, the aqueous electrolyte solution 20 may contain a solvent other than water, in addition to water. Examples of the solvent other than water include one kind or more of organic solvents selected from ether, carbonate, nitrile, alcohol, ketone, amine, amide, sulfur compounds, and hydrocarbon. With respect to the total amount (100 mol %) of solvents composing the aqueous electrolyte solution 20, the solvent other than water may be contained at 50 mol % or less, 30 mol % or less, 10 mol % or less, or 5 mol % or less.

### 3.3.2 Electrolyte

As the electrolyte, at least potassium polyphosphate can be dissolved in the aqueous electrolyte solution 20. The electrolyte can be dissociated into cations and anions, in the aqueous electrolyte solution 20. In the aqueous electrolyte solution 20, cations may be completely dissociated from anions, or aggregates that are, for example, close to anions may be formed. For example, potassium ions contained in the aqueous electrolyte solution may form an aggregates with anions. The aqueous electrolyte solution 20 may contain a plurality of kinds of cations. For example, the aqueous electrolyte solution 20 may contain the potassium ion, and may contain another cation together with the potassium ion. For example, an alkali metal ion other than the potassium ion, an alkaline-earth metal ion, a transition metal ion, and the like may be contained. Further, the aqueous electrolyte solution 20 naturally contains a proton. Further, the aqueous electrolyte solution 20 may contain one kind or more of anions. For example, the aqueous electrolyte solution 20 contains a polyphosphate anion. The kind of an anion other than the polyphosphate anion is not particularly limited. The aqueous electrolyte solution 20 naturally contains a hydroxide ion. As described above, the aqueous electrolyte solution 20 contains the proton and the hydroxide ion in addition to the cation and anion derived from potassium polyphosphate, and at least one kind of these ions can become a carrier ion. In the embodiment, the carrier ion may be the proton, may be the hydroxide ion, may be the cation derived from potassium polyphosphate, may be the anion derived from potassium polyphosphate, or may be a combination of them. The concentration of the electrolyte in the aqueous electrolyte solution 20 is not particularly limited. The concentration of the electrolyte in the aqueous electrolyte solution 20 can be adjusted depending on an intended performance. In the knowledge of the inventors, as the concentration of the electrolyte in the aqueous electrolyte solution 20 is higher, the potential window of the aqueous electrolyte solution 20 expands more easily. Further, as the concentration is higher, the capacity of the aqueous battery 100 becomes large more easily. Furthermore, as the concentration is higher, the elution of a current collector to the aqueous electrolyte solution 20 is restrained more easily. On the other hand, as the concentration is lower, the viscosity of the aqueous electrolyte solution 20 becomes low more easily.

The aqueous electrolyte solution 20 may contain various potassium compounds that can be dissolved in water, in addition to potassium polyphosphate, as the electrolyte. As such an electrolyte, there is at least one kind that is selected from KPF₆, KBF₄, K₂SO₄, KNO₃, CH₃COOK, (CF₃SO₂)₂NK, KCF₃SO₃, (FSO₂)₂NK, K₂HPO₄, KH₂PO₄, KPO₃, and the like.

In the knowledge of the inventors, the performance of the aqueous battery 100 becomes high more easily, in the case where the aqueous electrolyte solution 20 contains water and a phosphate or acetate of potassium dissolved in the water, particularly in the case where the aqueous electrolyte solution 20 contains water and a phosphate of potassium dissolved in the water, more particularly in the case where the aqueous electrolyte solution 20 contains water and potassium polyphosphate dissolved in the water. “Potassium polyphosphate” is a salt in which at least some of hydrogen of polyphosphoric acid is displaced by potassium. That is, “potassium polyphosphate” is a concept that includes hydrogen-potassium polyphosphate. Specific examples of potassium polyphosphate include potassium pyrophosphate (K₄₋ₓHₓP₂O₇), potassium tripolyphosphate (K₅₋ₓHₓP₃O₁₀), potassium tetrapolyphosphate (K₆₋ₓHₓP₄O₁₃), and potassium heptapolyphosphate (K₇₋ₓHₓP₅O₁₆). Particularly, in the case where potassium pyrophosphate (K₄₋ₓHₓP₂O₇) is employed as potassium polyphosphate, a further higher performance is easily secured. That is, the aqueous electrolyte solution 20 according to the embodiment may contain water and potassium pyrophosphate as the potassium polyphosphate dissolved in the water. As the electrolyte, the aqueous electrolyte solution 20 may contain a different electrolyte together with potassium polyphosphate. In this case, with respect to the total amount (100 mol %) of electrolytes dissolved in the aqueous electrolyte solution 20, potassium polyphosphate may be contained at 50 mol % or more and 100 mol % or less, at 70 mol % or more and 100 mol % or less, or at 90 mol % or more and 100 mol % or less, and the different electrolyte may be contained at 0 mol % or more and 50 mol % or less, at 0 mol % or more and 30 mol % or less, or at 0 mol % or more and 10 mol % or less.

In the aqueous electrolyte solution 20, “potassium polyphosphate dissolved in water” can be dissociated into potassium ions and anions. In the aqueous electrolyte solution 20, potassium ions may be completely dissociated from anions, or aggregates that are, for example, close to anions may be formed. For example, in the case where the aqueous electrolyte solution 20 contains potassium pyrophosphate dissolved in water, “potassium pyrophosphate dissolved in water” in the aqueous electrolyte solution 20 may exist as ions such as K⁺, P₂O₇⁴⁻, KP₂O₇³⁻, K₂P₂O₇²⁻, and K₃P₂O₇⁻, or as aggregates of the ions, may exist as HP₂O₇³⁻, H₂P₂O₇²⁻, H₃P₂O₇⁻, by extracting H⁺ from H₂O, or may be exist as HK₂P₂O₇⁻, HKP₂O₇²⁻, H₂KP₂O₇⁻, or the like, by aggregating H⁺ and K⁺. In the aqueous electrolyte solution 20, “the concentration of potassium polyphosphate dissolved in water” is identified by converting the ions, aggregates or the like contained in the aqueous electrolyte solution 20, in terms of potassium pyrophosphate. Further, in the case where the aqueous electrolyte solution 20 contains polyphosphate ions as anions (in the case of pyrophosphate ions, the pyrophosphate ions may exist while being connected with cations such as P₂O₇⁴⁻, KP₂O₇³⁻, K₂P₂O₇²⁻ and K₃P₂O₇⁻, HP₂O₇³⁻, H₂P₂O₇²⁻, H₃P₂O₇⁻, HK₂P₂O₇⁻, HKP₂O₇²⁻, and H₂KP₂O₇⁻, as described above), the whole of polyphosphate ions contained in the aqueous electrolyte solution 20 does not need to be converted as “the dissolved potassium polyphosphate”. That is, the aqueous electrolyte solution 20 may contain a larger amount of polyphosphate ions, compared to the concentration that allows the conversion as potassium polyphosphate. For example, in the case where a pyrophosphate ion source (for example, H₄P₂O₇ or the like) other than K₄P₂O₇ is added and dissolved in water together with K₄P₂O₇ when the aqueous electrolyte solution 20 is produced, the aqueous electrolyte solution 20 contains a larger amount of pyrophosphate ions, compared to the concentration that allows the conversion as potassium pyrophosphate. Meanwhile, in the case where a potassium ion source (for example, KOH) other than a potassium salt and an anion source (for example, H₄P₂O₇) other than a potassium salt each are dissolved in water and are dissociated into potassium ions and anions in the aqueous electrolyte solution 20, the potassium ions and the anions are converted as “potassium salt dissolved in water”. For example, in the case where KOH and H₄P₂O₇ are dissolved in the aqueous electrolyte solution 20, KOH and H₄P₂O₇ can be converted as potassium pyrophosphate.

The aqueous electrolyte solution 20 may contain water and potassium polyphosphate dissolved at a certain concentration or higher for 1 kg of water. For example, the concentration of potassium polyphosphate may be 2.0 mol or more, 2.5 mol or more, 3.0 mol or more, 3.5 mol or more, or 4.0 mol or more for 1 kg of water. The upper limit of the concentration of potassium polyphosphate in the aqueous electrolyte solution 20 is not particularly limited, but when the concentration is excessively high, there is fear that the viscosity of the aqueous electrolyte solution 20 excessively increases. In this regard, the concentration of potassium polyphosphate may be 8.0 mol or less, 7.0 mol or less, or 6.0 mol or less for 1 kg of water. In the case where the concentration of potassium polyphosphate is 2.0 mol or more for 1 kg of water, an oxidation-reduction resistance that is specific to a concentrated water solution and that is called water-in-salt is exerted, resulting in a further suitable aqueous electrolyte solution. Further, various physical properties described later can be secured.

### 3.3.3 Other Components

The aqueous electrolyte solution 20 may contain acids, hydroxides and others for adjusting the pH of the aqueous electrolyte solution 20, in addition to the above solvent and electrolyte. Further, various additive agents may be contained.

### 3.3.4 Physical Property of Aqueous Electrolyte Solution

(1) The pH of the aqueous electrolyte solution 20 is not particularly limited. However, when the pH is too high, there is fear that an oxidation-side potential window of the aqueous electrolyte solution becomes narrow. In this regard, the pH of the aqueous electrolyte solution may be 3 or higher and 13 or lower. The pH may be 4 or higher, 5 or higher, 6 or higher, 7 or higher, 8 or higher, 9 or higher, or 10 or higher, and may be 12 or lower.

(2) The aqueous electrolyte solution 20 may be an aqueous electrolyte solution that has no coagulation point at −60° C. or higher. Whether the aqueous electrolyte solution 20 has “coagulation point” is checked by differential scanning calorimetry (DSC). The sweep speed in the DSC is set to 5° C./min for both of temperature decrease and temperature increase, and the sweep range is set such that the temperature is decreased from room temperature to −120° C. and thereafter is increased to 40° C. Further, the atmosphere in the DSC is an inactive gas atmosphere such as an Ar atmosphere, and the pressure is set to a pressure equivalent to the atmospheric pressure. In the evaluation, an airtight aluminum container is used, and therefore, the atmosphere in the container is the atmospheric air that is enclosed under the atmospheric pressure. The measurement is performed for the aqueous electrolyte solution under the above condition, and in the case where no crystallization peak temperature (coagulation point temperature) is confirmed at −60° C. or higher, the aqueous electrolyte solution is regarded as “having no coagulation point at −60° C. or higher”. In the aqueous battery 100 in the present disclosure, for achieving the condition of “the aqueous electrolyte solution 20 has no coagulation point at −60° C. or higher”, it is effective to set the concentration of the electrolyte in the aqueous electrolyte solution 20 to a high concentration. In the case where the aqueous electrolyte solution 20 has no coagulation point at −60° C., free water molecules in the aqueous electrolyte solution 20 are reduced, and it is difficult for metals contained in the current collector to be eluted to the aqueous electrolyte solution 20. Further, when the aqueous electrolyte solution 20 has no coagulation point at −60° C., the aqueous battery 100 can be used even at a very low temperature. That is, the aqueous battery 100 appropriately operates even in cold areas.

(3) It is preferable that the aqueous electrolyte solution 20 be an aqueous electrolyte solution that does not cause salt deposition when the aqueous electrolyte solution 20 is cooled from 0° C. to −60° C. When the aqueous electrolyte solution 20 does not cause salt deposition due to temperature change in this way, ion conduction can be stably performed even at a low temperature. For example, the aqueous battery 100 can be used even at a very low temperature in cold areas or the like. As described above, the aqueous electrolyte solution 20 may contain water and potassium polyphosphate dissolved in the water. In the knowledge of the inventors, the saturation solubility of potassium polyphosphate in water has a low temperature dependency, and hardly changes at a low temperature of 0° C. or lower. In this regard, in the aqueous electrolyte solution 20 at 0° C., potassium polyphosphate is dissolved at a high concentration, and even when the aqueous electrolyte solution 20 is cooled from 0° C. to −60° C., the deposition of potassium polyphosphate in the aqueous electrolyte solution 20 does not substantially occur.

(4) When the viscosity of the aqueous electrolyte solution 20 is too high, the ion conductivity of the aqueous electrolyte solution 20 sometimes decreases. However, in the case where the electrolyte is dissolved in the aqueous electrolyte solution 20 at a high concentration, the aqueous electrolyte solution 20 can have a certain viscosity or higher. The aqueous electrolyte solution 20 may have a viscosity of 10 mPa·s or higher and 600 mPa·s or lower at 20° C.

### 3.4 Anode Active Material Layer

The anode active material layer 31 contains an anode active material. Further, the anode active material layer 31 may contain a conductive auxiliary agent, a binder, various additive agents, and the like, other than the anode active material. Further, the anode active material layer 31 can be impregnated with the aqueous electrolyte solution 20. The content of each component in the anode active material layer 31 may be appropriately determined depending on an intended battery performance. For example, when the whole (the whole solid content) of the anode active material layer 31 is 100 mass %, the content of the anode active material may be 40 mass % or more, and may be 100 mass % or less or 90 mass % or less. The shape of the anode active material layer 31 is not particularly limited, and for example, a sheet-shaped anode active material layer having a roughly planar surface may be adopted.

### 3.4.1 Anode Active Material

As the anode active material, a known anode active material of the aqueous battery may be employed. For example, the anode active material may include at least one kind selected from a potassium-transition metal complex oxide; titanium oxide; a metal sulfide such as Mo₆S₈; elemental sulfur; KTi₂(PO₄)₃; a NASICON type compound; WO₃, and the like. Alternatively, the anode active material may be a hydrogen storing alloy. Alternatively, the anode active material may be an inorganic compound having a crystal structure that belongs to a space group I23. The inorganic compound having a crystal structure that belongs to the space group I23 may include an element A, an element M, and O, for example. The element A is at least one of Bi and La, and the element M is at least one of Bi, Mn, Fe, Co, and Ni. Both of the element A and the element N may be Bi. The anode active material may remove and insert ions by intercalation, or may remove and insert ions by a conversion reaction, an alloying reaction, or the like. As the anode active material, only one kind may be used alone, or two kinds or more may be combined and used. The shape of the anode active material only needs to be a shape that allows the function as the anode active material of the battery. For example, the anode active material may be a particle shape. The anode active material may be a primary particle, or may be a secondary particle in which a plurality of primary particles is aggregated. For example, the average particle diameter D50 of the anode active material may be 1 nm or more and 1000 μm or less. The lower limit may be 5 nm or more or 10 nm or more, and the upper limit may be 500 μm or less, 100 μm or less, 50 μm or less, or 30 μm or less.

### 3.4.2 Other Components

The conductive auxiliary agent and binder that can be contained in the anode active material layer 31 may be appropriately selected from the above-exemplified agents that can be contained in the cathode active material layer 11. As each of the conductive auxiliary agent or binder, only one kind may be used alone, or two kinds or more may be combined and used.

### 3.5 Anode Current Collector

As shown in FIG. 1, an anode 30 of the aqueous battery 100 can include an anode current collector 32 that contacts with the above anode active material layer 31. The anode current collector 32 may contact with the aqueous electrolyte solution 20. For the anode current collector 32, any anode current collector that can function as the anode current collector of the aqueous battery can be employed. The anode current collector 32 may be a foil, a plate, a mesh, a punched metal, a foam, or the like. The anode current collector 32 may be composed of a metal foil or a metal mesh. Particularly, the metal foil has a high handling property and the like. The anode current collector 32 may be constituted by a plurality of foils. As the metal material composing the anode current collector 32, for example, there is a material containing at least one element that is selected from a group constituting of Cu, Ni, Al, V, Au, Pt, Mg, Fe, Ti, Pb, Co, Cr, Zn, Ge, In, Sn, and Zr. Particularly, the anode current collector 32 containing at least one selected from a group constituting of Al, Ti, Pb, Zn, Sn, Mg, Zr, and In, more particularly, the anode current collector 32 containing Al has a high performance. Each work function of Al, Ti, Pb, Zn, Sn, Mg, Zr and In is low, and the electrolysis of the aqueous electrolyte solution 20 is unlikely to occur even when the anode current collector 32 makes contact with the aqueous electrolyte solution 20 at a reduction potential. The anode current collector 32 may be formed by plating or evaporating the above metal on a metal foil or a base material. Further, in the case where the anode current collector 32 is constituted by a plurality of metal foils, some kind of layer may be provided among the plurality of metal foils. The thickness of the anode current collector 32 is not particularly limited. For example, the thickness may be 0.1 μm or more or 1 μm or more, and may be 1 mm or less or 100 μm or less.

### 3.6 Other Configurations

The aqueous battery 100 may include other configurations described below, in addition to the above basic configuration. As described above, in the aqueous battery 100, the separator 40 may be provided between the cathode active material layer 11 and the anode active material layer 31. As the separator 40, a separator that is used in the aqueous electrolyte battery (a nickel-hydrogen battery, a zinc air battery, or the like) may be employed. For example, a separator having hydrophilicity, as exemplified by a non-woven fabric composed of cellulose, may be adopted. The thickness of the separator 40 is not particularly limited, and for example, may be 5 μm or more and 1 mm or less. The aqueous battery 100 may include terminals, a battery case, and the like, in addition to the above configuration. The aqueous battery 100 may be a secondary battery.

### 4. Production Method for Aqueous Battery

For example, the aqueous battery 100 in the present disclosure can be produced as described below.

(1) A cathode mixture paste (slurry) is obtained by dispersing the cathode active material and the like that compose the cathode active material layer 11, in a solvent. As the solvent that is used in this case, water or various organic solvents can be used. The cathode mixture paste (slurry) is applied on the surface of the cathode current collector 12, using a doctor blade or the like, and thereafter, by drying, the cathode active material layer 11 is formed on the surface of the cathode current collector 12, so that the cathode 10 is obtained. As the application method, an electrostatic applying method, a dip-coating method, a spray coating method, or the like can be employed in addition to the doctor blade method.

(2) For example, the aqueous electrolyte solution 20 can be produced by blending water and the electrolyte. Simply by filling a container with water and the electrolyte and holding them there, the water and the electrolyte mix with each other, and finally, the aqueous electrolyte solution 20 is obtained.

(3) An anode mixture paste (slurry) is obtained by dispersing the anode active material and the like that compose the anode active material layer 31, in a solvent. As the solvent that is used in this case, water or various organic solvents can be used. The anode mixture paste (slurry) is applied on the surface of the anode current collector 32, using a doctor blade or the like, and thereafter, by drying, the anode active material layer 31 is formed on the surface of the anode current collector 32, so that the anode 30 is obtained. As the application method, the electrostatic applying method, the dip-coating method, the spray coating method, or the like can be employed in addition to the doctor blade method.

(4) The aqueous battery 100 is obtained by housing the cathode 10, the aqueous electrolyte solution 20 and the anode 30 in the battery case. For example, the separator 40 is sandwiched between the cathode 10 and the anode 30, and thereby, a laminated body including the cathode current collector 12, the cathode active material layer 11, the separator 40, the anode active material layer 31 and the anode current collector 32 in this order is obtained. As necessary, other members such as terminals are attached to the laminated body. The laminated body is housed in the battery case, the battery case is filled with the aqueous electrolyte solution 20 such that the laminated body is immersed in the aqueous electrolyte solution 20, and the laminated body and the electrolyte solution are stored in the battery case in a sealed manner, so that the aqueous battery 100 can be obtained.

The technology in the present disclosure will be further specifically described below, with an example and a comparative example, but the technology in the present disclosure is not limited to them.

### 1. Production of Cathode Active Material

### 1.1 Example: Production of Cathode Active Material by Soft Chemical Method

### 1.1.1 Synthesis of Precursor

As starting materials, sodium carbonate, dimanganese trioxide, and dibismuth trioxide were weighted such that the molar ratio was 1:0.95:0.05, and were pulverized and blended for 2 hours using a planetary ball mill, so that a blended material was obtained. The obtained blended material was put in an alumina crucible, was placed in a baking furnace, and oxygen was removed by the flowing of nitrogen gas into the furnace. Thereafter, in this state, the temperature was increased to 750° C. at a temperature increase rate of 150° C./h, and the blended material was held at 750° C. for 60 hours. Thereby, the baking of the blended material was performed. Thereafter, the gradual cooling to room temperature was performed, and after the flowing of nitrogen gas was stopped, a precursor that was the baked material was retrieved from the furnace. The X-ray diffraction pattern of the obtained precursor was checked. The precursor had the same diffraction pattern as single-phase α-NaMnO₂, and it was determined that Bi was taken in the crystal structure.

### 1.1.2 Acid Treatment of Precursor

The precursor obtained described above was put in a 300-ml beaker, and 250 ml of a sulfuric acid solution (sulfuric acid concentration: 0.3 mol/L) was added in the beaker, and was stirred at 20° C. for 24 hours. After the end of the stirring, suction filtration was performed using a Bucher funnel, and the water washing with a BaCl₂ water solution was performed such that a white precipitate of BaSO₄ was not generated. Thereby, a wet cake was obtained. The obtained wet cake was dried at 50° C. for 24 hours by a warm-air dryer, and thereafter, was classified using a standard sieve with openings of 30 μm, so that the cathode active material was obtained.

### 1.1.3 Check of Crystal Structure and Composition

The X-ray diffraction pattern of the obtained cathode active material was checked using CuKα as the radiation source. The X-ray diffraction pattern of the cathode active material according to the example is shown in FIG. 2. As shown in FIG. 2, it was confirmed that the cathode active material had a single-phase monoclinic layered crystal structure belonging to the space group C2/m. Further, element analysis was performed to the obtained cathode active material by IPC measurement. It was confirmed that a composition ratio Na/(Mn+Bi) of Na to the total of Mn and Bi in the cathode active material was 0.05, a composition ratio Bi/(Mn+Bi) of Bi to the total of Mn and Bi was 0.04, and 13.7 mass % water was contained. In other words, the cathode active material according to the example had a monoclinic crystal structure belonging to the space group C2/m, and had a composition shown as a composition formula: Na_{0.05}Mn_{0.96}Bi_{0.04}O₂·0.83H₂O.

### 1.2 Comparative Example: Production of Cathode Active Material by Solution Method

### 1.2.1 Preparation of Solution

Ion exchanged water was added to 19.8 g of manganese (II) chloride tetrahydrate, and 200 ml of 0.5 mol/L manganese chloride water solution was prepared. Further, ion exchanged water was added to 109 g of 50 w/w % sodium hydroxide water solution, and 250 ml of 5.5 mol/L sodium hydroxide water solution was prepared.

### 1.2.2 Production of Cathode Active Material by Solution Reaction

The above manganese chloride water solution was transferred into a 1-L stirring container allowing gas flow, was further set in a cooling bath, and was cooled until the temperature became 10° C. or lower. The bubbling of Ar gas was performed while stirring was performed, and thereby, the air in the container was forced out. While temperature maintenance, gas bubbling and stirring were performed, the above prepared sodium hydroxide water solution was added to the manganese chloride water solution for 15 minutes by a roller pump, and blending was performed, so that a clouded slurry was generated. Thereafter, a gas pipe was connected to an air pump, air was sent at 6 L/min, and bubbling was continued for 20 hours or more. The oxidation reaction was promoted such that the slurry was blackened. After the end of the reaction, filtration was performed using a Bucher funnel, and the water washing with a AgNO₃ water solution was performed such that a white precipitate of AgCl was not generated, so that a wet cake was obtained. The obtained wet cake was dried at 80° C. for a day and a night by a warm-air dryer, and thereafter, was classified using a standard sieve with openings of 38 μm, so that the cathode active material was obtained.

### 1.2.3 Check of Crystal Structure and Composition

The X-ray diffraction pattern of the obtained cathode active material was checked using CuKα as the radiation source. The X-ray diffraction pattern of the cathode active material according to the comparative example is shown in FIG. 2. As shown in FIG. 2, it was confirmed that the cathode active material had a single-phase monoclinic layered crystal structure belonging to the space group C2/m. Further, element analysis was performed to the obtained cathode active material by IPC measurement. It was confirmed that a composition ratio Na/Mn of Na to Mn in the cathode active material was 0.29 and 10.9 mass % water was contained. In other words, the cathode active material according to the comparative example had a monoclinic crystal structure belonging to the space group C2/m, and had a composition shown as a composition formula: Na_{0.29}MnO₂·0.64H₂O.

### 2. Production of Cathode

The above cathode active material, acetylene black as the conductive auxiliary agent, and PVdF as the binder were blended together with a solvent, such that the mass ratio was cathode active material:conductiveauxiliaryagent:binder=75:20:5. Thereby, an ink was produced. The obtained ink was dropped on a surface of a Ti foil, and thereafter, is applied by a doctor blade, such that a uniform film was made. Thereby, the cathode including the Ti foil and the cathode active material layer provided on the surface of the Ti foil was obtained.

### 3. Production of Aqueous Electrolyte Solution

The aqueous electrolyte solution for evaluation was obtained by dissolving 5 mol of K₄P₂O₇ in 1 kg of pure water. The aqueous electrolyte solution had a pH in a range of 3 or higher and 13 or lower, had no coagulation point at −60° C. or higher, did not cause salt deposition when cooling was performed from 0° C. to −60° C., and had a viscosity in a range of 10 mPa·s or higher and 350 mPa·s or lower at 20° C.

### 4. Production of Evaluation Cell

An evaluation cell (VM4, EC Frontier Co. Ltd.) was produced using the above cathode as a working electrode, a Pt mesh as a counter electrode, Ag/AgCl as a reference electrode, and the above aqueous electrolyte solution.

### 5. Evaluation of Cell

The charge and discharge of the evaluation cell were performed under the following condition, and a discharge curve was obtained.
Charge-discharge current value: 0.2 mA/cm²
Cut voltage: −0.5 to 0.85 V vs. Ag/AgCl
Measurement temperature: 25° C.

### 6. Evaluation Result

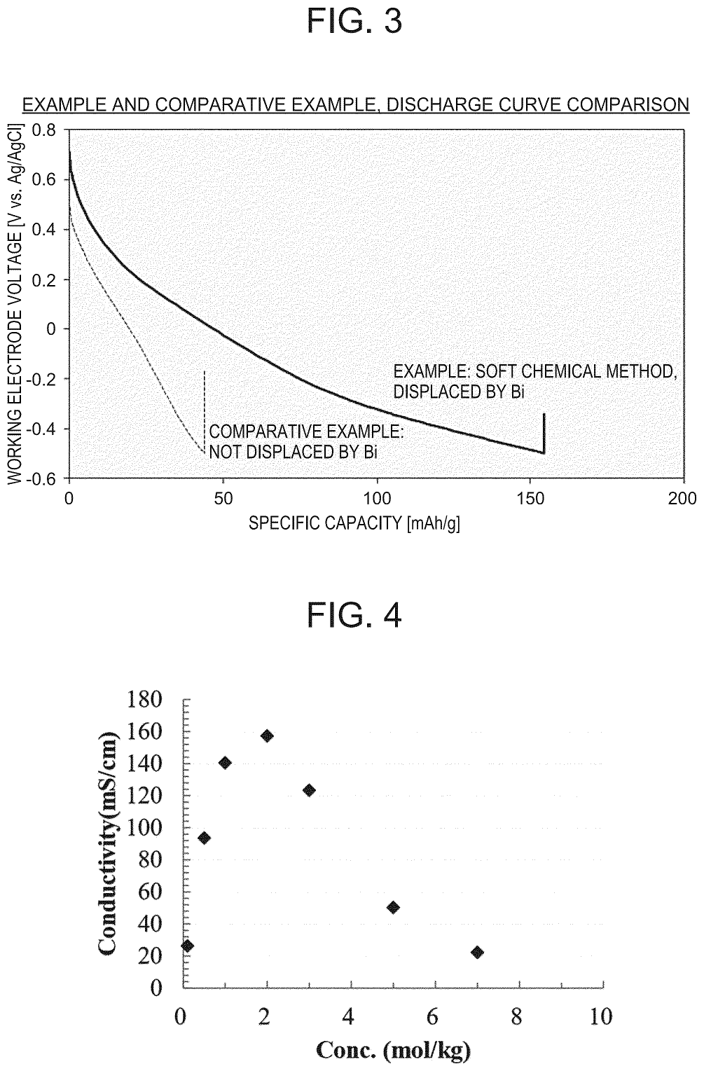

FIG. 3 shows each of the discharge curve of a cell according to the example and the discharge curve of a cell according to the comparative example. As shown in FIG. 3, it is found that the cathode active material according to the example allowed charge and discharge in the aqueous electrolyte solution containing potassium polyphosphate and had a significantly higher discharge capacity than the cathode active material according to the comparative example. It is thought that the stabilization of the crystal structure and/or the change in the electronic state in the crystal was caused by the existence of not only Mn but also Bi in the monoclinic crystal structure belonging to the space group C2/m, in the cathode active material according to the example. Therefore, it is thought that charge compensation ions (for example, potassium ions and/or protons) derived from the aqueous electrolyte solution easily went into between layers in the crystal structure and the discharge capacity increased.

### 7. Supplement

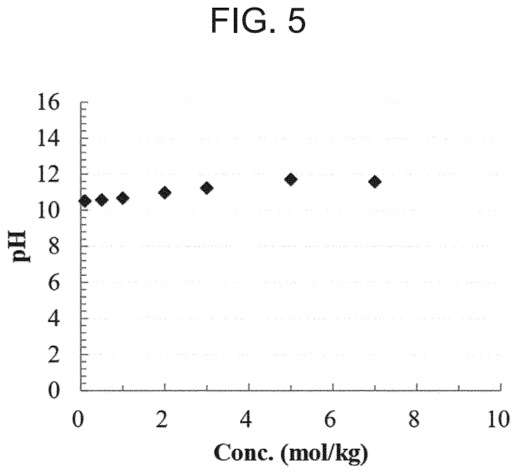

FIG. 4 shows a relation between the concentration and ion conductivity in the potassium pyrophosphate water solution. As shown in FIG. 4, in the case where the concentration of potassium pyrophosphate in the potassium pyrophosphate water solution is higher than 0 mol/kg and is 8 mol/kg or lower, the potassium pyrophosphate water solution has a high ion conductivity. Further, FIG. 5 shows a relation between the concentration and pH in the potassium pyrophosphate water solution. As shown in FIG. 5, in the case where the concentration of potassium pyrophosphate in the potassium pyrophosphate water solution is higher than 0 mol/kg and is 8 mol/kg or lower, the pH of the potassium pyrophosphate water solution is 10.0 to 12.0.

In the above example, the performance of the active material contained in the cathode was evaluated in a simplified manner, using an evaluation cell including the predetermined aqueous electrolyte solution, the predetermined cathode as the working electrode, the Pt mesh as the counter electrode, and Ag/AgCl as the reference electrode. The configuration other than the cathode active material is not essential for the technology in the present disclosure. In the case where the aqueous battery is actually configured, the aqueous electrolyte solution, the anode and the like may be employed together with the predetermined cathode active material.

What is claimed is:

1. A cathode active material having a monoclinic crystal structure that belongs to a space group C2/m,
the cathode active material having a composition shown as follows,
AₓMn_{1-y}Bi_{y}O₂·zH₂O Composition formula:
A: one or both of Na and K
$$0 < x < 1$$
$$0 < y < 1$$
$$0 < z < 2 ,$$
the cathode active material being used in an aqueous battery including an aqueous electrolyte solution containing water and potassium polyphosphate that is dissolved in the water.

2. An aqueous battery comprising:
a cathode active material layer;
an aqueous electrolyte solution; and
an anode active material layer, wherein:
the cathode active material layer contains the cathode active material according to claim 1; and
the aqueous electrolyte solution contains water and potassium polyphosphate that is dissolved in the water.

3. The aqueous battery according to claim 2, wherein the aqueous electrolyte solution contains water and potassium polyphosphate that is dissolved at a concentration of 2.0 mol or more per 1 kg of the water.

4. The aqueous battery according to claim 2, wherein the aqueous electrolyte solution contains water and potassium pyrophosphate as the potassium polyphosphate that is dissolved in the water.

5. The aqueous battery according to claim 2, wherein a pH of the aqueous electrolyte solution is 3 or higher and 13 or lower.
